(19) United States
(12) Patent Application Publication
(10) Pub. No.: US 2013/0145846 A1
(43) Pub. Date: Jun. 13, 2013

(54) Method of Balancing Tires

(71) Applicant: Robert K. Minieri, Conroe, TX (US)

(72) Inventor: Robert K. Minieri, Conroe, TX (US)

(21) Appl. No.: 13/314,307

(22) Filed: Dec. 8, 2011

(51) Int. Cl. G01M 1/16

(52) U.S. Cl. 73/462

(57) ABSTRACT

A method of balancing tires on a wheel for passenger vehicles, trucks, and the like includes positioning one or more balancing weights in a groove in the tire tread. A novel weight that locks within the groove is also described.

### BACKGROUND OF INVENTION

1. Field of the Invention

This invention relates to the balancing of tires mounted on wheels such as those employed on passenger cars and trucks. Tires for passenger cars and trucks are initially and periodically balanced on the wheel in order to prevent uneven wear of the tire treads and excessive vibration.

2. Description of Related Art

Various methods are currently used in order to balance tires. A common method is to spin the tire and wheel on a support Unbalanced forces are sensed via electronic sensors that generate electronic signals which are recorded to determine the magnitude and position of balancing weights to be installed on the tire/wheel assembly to counteract the unbalanced forces. Such a machine is described in U.S. Pat. No. 4,336,715. U.S. Pat. Nos. 2,339,718 and 3,786,850 disclose the technique of applying balancing weights to the side walls of tires mounted on a wheel in order to balance the assembly. Weights applied in the above manners are prone to separate from the wheel or tire and are not esthetically pleasing in all instances.

### BRIEF SUMMARY OF THE INVENTION

The invention described and claimed herein is a method of balancing a tire/wheel assembly which involves determining the location and amount of weights to be secured to the assembly and applying the balancing weight between the tire treads as described below. The weight includes an attaching mechanism for securing the weight in the tire treads. In this manner, the weights are firmly secured to the tires and are out of sight.

### BRIEF DESCRIPTION OF THE SEVERAL VIEWS OF THE DRAWING(S)

FIG. 1 is a perspective view of an embodiment of a balancing weight for use in the invention,

FIG. 2 is a sectional view of the weight shown in FIG. 1.

FIG. 3 is a top view of the weight shown in FIG. 1 and

FIG. 4 is a sectional view of the weight positioned within the tread of a tire.

### DETAILED DESCRIPTION OF THE INVENTION

The invention of the current application is directed to balancing a tire on a wheel of a passenger car or truck for example by utilizing balancing weights that are embedded in the tread of the tire. In order to determine the amount of weight and its placement on the tire and wheel, the assembly is attached to any one of a plurality of known tire balancing machines such as that described in U.S. Pat. No. 4,336,715. These machines rotate the tire/wheel and determine the amount of weight and location needed.

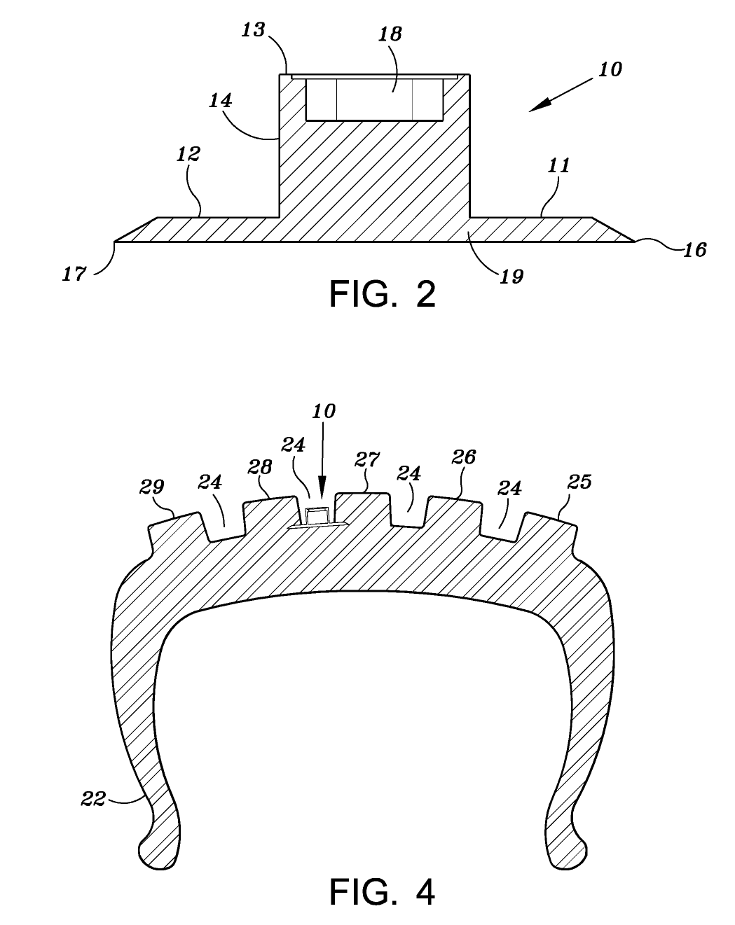

Typically in the prior art the weights are of the type that attach to an inner or outer rim of the wheel. In place of this approach, the current invention involves placing the balancing weights within the tire tread as sown in FIG. 4. The tread of a conventional tire 22 includes a plurality of ridges 25, 26, 27, 28, and 29 with associated grooves 24. The balancing weights 10 are placed within grooves 24 as determined by the tire balancing machine.

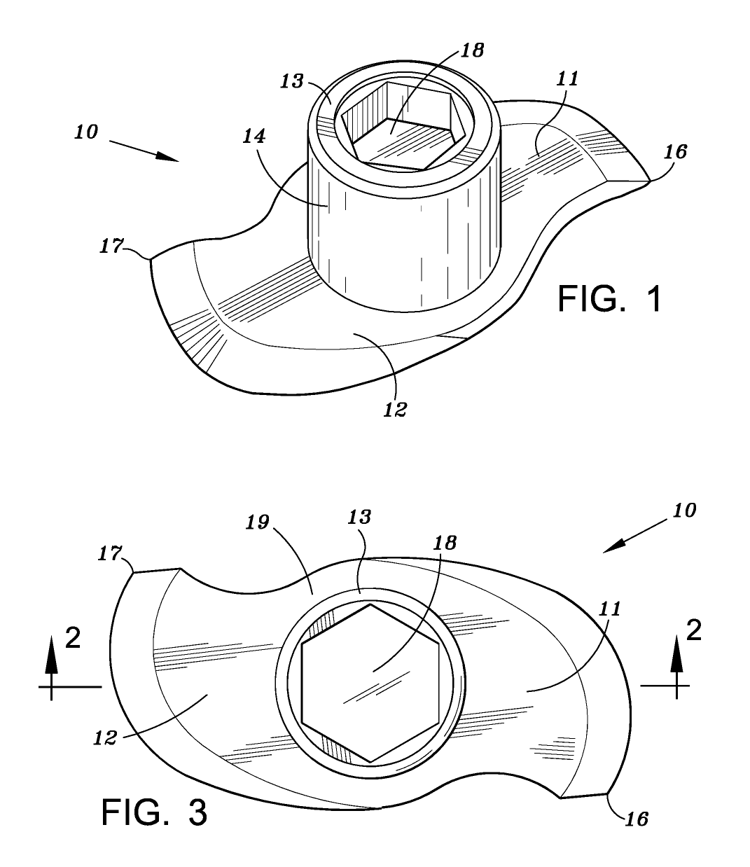

As depicted in FIGS. 1-3, each weight 10 includes an upstanding central portion 14 which has an opening 18 to receive a drive wrench or the like. Alternatively the outer surface of the central portion 14 could be configured to receive a socket tool. While a hexagonal opening is illustrated, the opening could be of any shape, such as a star shape or rectangular shape.

The central portion 14 extends from a base portion 19 that includes two wing portions 11 and 11 Wing portions 11 and 12 have a beveled edge portion 16 and 17. Wing portions 11 and 12 and base portion 19 are sized to fit within the grooves of the tire tread. Once inserted, the weight can be rotated using an appropriate drive wrench so that wings 11 and 12 cut into the tread ridges at the bottom of the groove as shown in FIG. 4. When installed, the top portion of the weight is preferably located at a position which corresponds to the lowest amount of tread life so as not to interfere with the useful life of the tire. The weight may be formed of lead or any other suitable material.

In use, a plurality of weights of different sizes and configurations would be provided so that a plurality of difference size tires and grooves could be accommodated.

Furthermore while the embodiment of the balancing weights shown in FIGS. 1-4 includes the two beveled wings, other known attachment arrangements could be employed. For example, the weights could have self-taping screw threads or barbs on the base portion 19.

Although the present invention has been described with respect to specific details, it is not intended that such details should be regarded as limitations on the scope of the invention, except to the extent that they are included in the accompanying claims.

I claim:

1. A method of balancing a tire and wheel assembly wherein the tire includes a tread having ridges and grooves comprising:
placing the tire and wheel assembly on a tire balancing machine that indicates the amount and placement of balancing weights required to balance the tire/wheel assembly,
providing at least one balancing weight having means for securing the balancing weight in the grooves of the tire tread,
selecting at least one balancing weight that corresponds to the amount of weight necessary to balance the tire as determined by the tire balancing machine, and
positioning the at least one balancing weight within the groove of the tire tread at the location determined by the tire balancing machine.

2. The method of claim 1 wherein at least one balancing weight includes two wings having beveled edges that cut into adjacent ridges to secure the balancing weights within the groove.

3. A balancing weight for balancing a tire/wheel assembly comprising:
a base member,
a central portion extending from the base member,
an upper portion of the central portion having a configuration adapted to receive a tool, and
means on the base member for securing the balancing weight within a groove provided in a tread portion of the tire.

4. A balancing weight as claimed in claim 6 wherein the means on the base member for securing the balancing weight within a groove provided in a tread portion of the tire includes two, oppositely extending wings having beveled portions.

5. A balancing weight as claimed in claim 6 wherein the weight is sized to be positioned entirely within the groove portion of the tread when installed.

6. The balancing weight as claimed in claim 6 wherein the central portion has a surface adapted to receive a tool for positioning the balancing weight within the groove.
